(19) United States
(12) Patent Application Publication
(10) Pub. No.: US 2003/0067543 A1
(43) Pub. Date: Apr. 10, 2003

(54) Camera server system

(75) Inventors: Hiroyuki Okada, Izumi-Shi (JP); Takashi Kondo, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/263,265

(22) Filed: Oct. 2, 2002

(30) Foreign Application Priority Data
Oct. 9, 2001 (JP) P2001-311743

(51) Int. Cl. H04N 5/225

(52) U.S. Cl. 348/207.1; 348/211.2

(57) ABSTRACT

An object of the present invention is to provide a technique capable of easily managing information whether image data obtained by each of a plurality of cameras can be received by each of a plurality of external monitor means. Image data obtained by a plurality of cameras are transmitted to a server via communication network. When data requesting transmission of the image data obtained by the cameras are sent from the portable telephones to the server, a reception data identifying unit identifies a portable telephone and a camera from device identification data and a camera specifying number in the data requesting the transmission of the image data. When a reception permission determining unit determines that the portable telephone is permitted to receive the image data obtained by the camera on the basis of reception permission information stored in a flash ROM, under control of an overall control unit, desired image data is transmitted from a data output unit to the portable telephone as a transmission request source via a network.

This application is based on application No. 2001-311743 filed in Japan, the contents of which are hereby incorporated by reference.

### BACKGROUND OF THE INVENTION

1. Field of the Invention

The present invention relates to a technique of reception restriction for managing whether image data obtained by a plurality of cameras can be received by a plurality of monitor means (image display devices).

2. Description of the Background Art

Conventionally, a network camera system for observing an image obtained by a camera connected to a network by using a personal computer or the like connected to the network in another place is used in many places.

Depending on the place of the camera, however, there is a case that the user does not want to show the image to the other people. A technique for restricting an access to the camera from another place by, for example, obligation of entering a password to access the camera from a personal computer or the like in another place, or by performing IP address filtering in which an IP address is regarded as a password is proposed and practically used.

In the network camera, however, it is necessary to perform a setting for restricting an access by a circuit or a computer built in each camera, and operations for performing a setting to restrict the access, changing the setting and the like have been complicated.

### SUMMARY OF THE INVENTION

The present invention is directed to a camera server system connected to a plurality of image display devices via a communication network.

According to one aspect of the present invention, the camera server system includes: a plurality of cameras; and a server for performing data communications with the plurality of cameras. The server includes a storing unit for storing information indicating, for each display device, images obtained by which cameras among the plurality of cameras are permitted to be received by the each display device; and a control unit for referring the information and conducting a process related to an objective camera in response to a command requested only from respective ones of image display devices which are permitted to receive images obtained by the objective camera.

Since whether or not image data obtained by each camera can be received by each image display device is managed by a single server, setting and management of permitting whether an image obtained by each camera can be displayed on each image display device or not can be easily performed. Only the holder of an image display device capable of receiving image data obtained by a camera can execute a predetermined operation on the camera.

In one preferred aspect of the present invention, the control unit conducts the process related to the objective camera only when a same command is requested from all of the respective ones of image display devices which are permitted to receive images obtained by the objective camera.

According to the intention of the holder of the image display device capable of receiving image data obtained by a camera, each camera is allowed to execute a predetermined operation, and a switch can be easily made between a state where an image captured by each camera can be displayed on an image display device and a state where an image captured by each camera cannot be displayed on an image display device. Particularly, when even one of holders of image display devices capable of displaying images captured by a camera does not want to show the images captured by the camera to the others, a state where the images captured by the camera cannot be displayed on all of the image display devices can be set.

In another preferred aspect of the invention, the control unit conducts the process related to the objective camera in response to a command requested by either one of image display devices which are permitted to receive images obtained by the objective camera.

Therefore, according to the intention of the holder of the image display device capable of receiving image data obtained by each camera, each camera is allowed to execute a predetermined operation, and a switch can be easily made between a state where an image captured by each camera can be displayed on an image display device and a state where an image captured by each camera cannot be displayed on an image display device. Particularly, by one of holders of image display devices capable of displaying images captured by each camera, a state where the images captured by the camera can be displayed on the image display devices can be set.

In another preferred aspect of the present invention, said information includes a part which is set for a camera group constituting of two or more cameras among the plurality of cameras.

A setting for permitting whether each of the image display devices can receive image data obtained by a camera or not can be made more easily.

The present invention is also directed to a server connected to a plurality of cameras for obtaining image data and a plurality of image display devices via a communication network.

The present invention is also directed to a computer program product storing a software program capable of allowing a computer provided in a server connected to a plurality of cameras for obtaining image data and a plurality of image display devices via a communication network to execute a process.

Therefore, an object of the present invention is to provide a technique capable of easily managing information whether image data captured by a plurality of cameras can be received by a plurality of external image display devices or not.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an outline of a first preferred embodiment according to the present invention;

FIG. 2 is a diagram showing an example of reception permission information stored and managed in a flash ROM 14b;

FIGS. 3A to 3E are diagrams for describing data transmitted/received between a server 10 and portable telephones P1 to P3;

FIG. 4 is a flowchart showing the operations executed by the server 10;

FIG. 5 is a flowchart showing the operations executed by the server 10;

FIG. 6 is a flowchart showing the operations executed by the server 10;

FIG. 7 is a diagram showing an example of monitor mode setting information stored and managed by the flash ROM 14b;

FIG. 8 is a flowchart showing operations executed by the server 10 according to a second preferred preferred embodiment;

FIG. 9 is a flowchart showing operations executed by the server 10 according to the second preferred preferred embodiment;

FIG. 10 is a diagram showing the outline of a modification according to the present invention; and

FIG. 11 is a diagram showing a modification of reception permission information stored and managed by the flash ROM 14b.

### DESCRIPTION OF THE PREFERRED EMBODIMENTS

Preferred embodiments of the present invention will be described in detail hereinafter with reference to the drawings.

First Preferred Embodiment

Outline of System

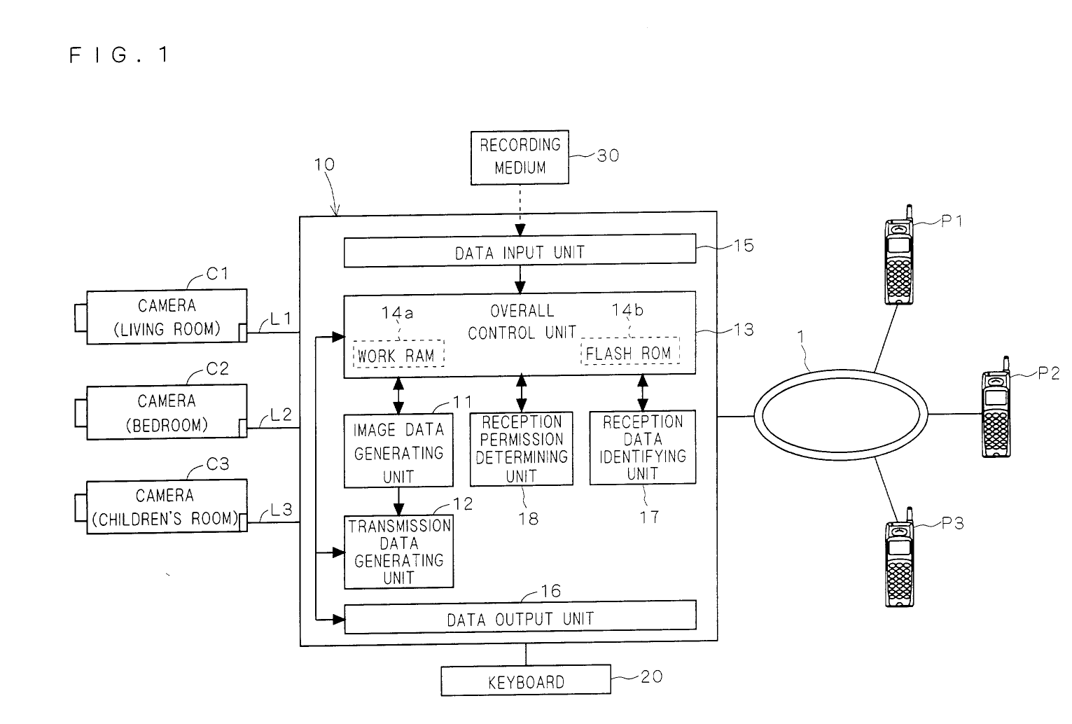

FIG. 1 is a diagram showing the outline of a first preferred embodiment according to the present invention. FIG. 1 shows, as an example, a monitoring system for use at home.

As shown in FIG. 1, cameras C1 to C3 are disposed in a plurality of rooms (in this case, a living room, a bedroom and a children's room), a server 10 functioning as a video server is disposed in a place in a house, and the cameras C1 to C3 and the server 10 are connected to each other via communication lines L1 to L3. Further, the server 10 is connected to external terminals (in this case, portable telephones P1 to P3) via a network 1.

The “network” is a communication line network for performing data communications, which is concretely any of various communication line networks each constructed by electric communication lines (including optical communication lines) such as the Internet, LAN, WAN or CATV. A form of connection to a network may be a continuous connection using a dedicated line or the like or a temporary connection such as a dial-up connection using a telephone line such as an analog line or digital line (ISDN). The transmission system may be a radio transmission system or a wired transmission system.

Each of the cameras C1 to C3 is, for example, a digital camera (digital movie camera or digital still camera) for capturing images in each room. Each of the cameras C1 to C3 is, although not shown, image pickup means having a lens as a component of an image pickup optical system and a CCD (image element) for generating electric image data of a subject from an image of the subject formed by the lens. In each of the cameras C1 to C3, image data obtained by the CCD is subjected to an analog signal process such as reduction of noise in an image signal and level adjustment of the image signal, and converted into a digital signal. Image data as the digital signal is transmitted to the server 10 via the communication lines L1 to L3. The flow of data and functions in the cameras C1 to C3 are controlled by a camera control unit mainly constructed by a not-shown CPU.

The cameras C1 to C3 obtain data transmitted from the server 10 via the communication lines L1 to L3, and image capturing is started or stopped under control of the camera control unit in accordance with an instruction included in the data.

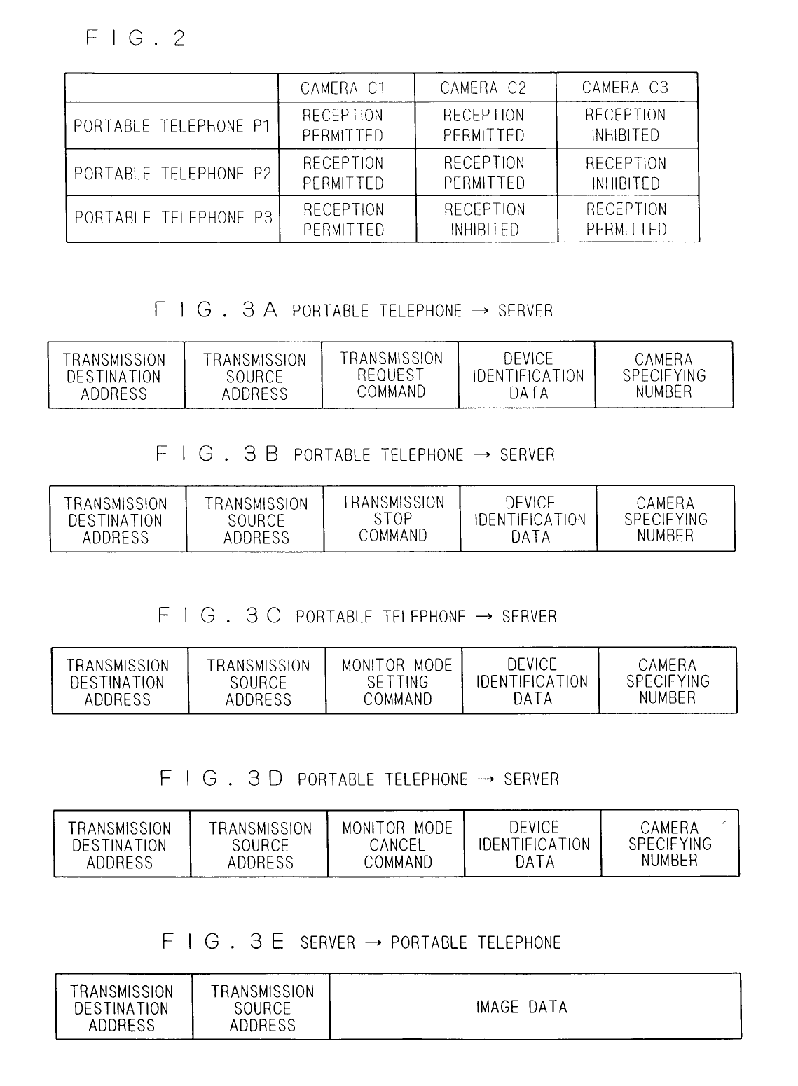

The server 10 receives the image data transmitted from the cameras C1 to C3 by a data input unit 15, performs black level correction, white balance automatic adjustment, and γ correction by an image data generating unit 11, and transmits the resultant image data to a transmission data generating unit 12. The transmission data generating unit 12 performs a predetermined compressing process by two-dimensional DCT, the JPEG system such as Huffman coding, or the like on the image data, and generates transmission data shown in FIG. 3E which will be described hereinafter constructed by image data as compression image data to be transmitted to the outside, transmission destination address data, and transmission source address data.

The data input unit 15 receives data transmitted from the external portable telephones P1 to P3 via the network 1. A reception data identifying unit 17 identifies the contents of the received data. On the basis of reception permission information stored in a flash ROM 14b which will be described hereinafter, a reception permission determining unit 18 transmits instruction data to transmit the image data obtained by the cameras C1 to C3, that is, the image data transmitted from the cameras C1 to C3 to the server 10 from a data output unit 16 to the portable telephones P1 to P3 via the network 1 and to set a monitor mode to the cameras C1 to C3. In this case, each of the image data generating unit 11, transmission image data generating unit 12, reception data identifying unit 17, and reception permission determining unit 18 is configured by a dedicated electronic circuit. The flow of data, operations of functions, and the like in the server 10 are controlled by an overall control unit 13 mainly constructed by a CPU.

The overall control unit 13 has therein a work RAM 14a taking the form of a DRAM and a flash ROM 14b for storing a program, and performs various controls and processes in accordance with a program stored in the flash ROM 14b. Further, the overall control unit 13 controls whether a camera is in a monitor mode as an image capturing state. The image capturing state is always stored and managed as monitor mode setting information in the flash ROM 14b. The operations will be described in detail hereinafter. A program can be installed from an external recording medium 30 into the flash ROM 14b via the data input unit 15.

Each of the portable telephones P1 to P3 has a display screen for displaying an image and is a monitor means (image display device) for monitoring and displaying an image obtained by the cameras C1 to C3 and received via the server 10 and the network 1. By a predetermined operation of the holder, the portable telephones P1 to P3 transmit data for requiring transmission of image data obtained by the cameras C1 to C3 or stopping the transmission and data for requiring setting or cancel of the monitor mode for switching between start and stop of image capture by the cameras C1 to C3 to the server 10 via the network 1. The portable telephones P1 to P3 can receive image data transmitted from the server 10 via the network 1, decode compression-encoded image data by a not-illustrated decoder, and display an image (moving image or still image) obtained by the cameras C1 to C3 on the display screen.

Management of Reception Permission by Server 10

FIG. 2 is a diagram showing an example of reception permission information stored and managed by the flash ROM 14b in the server 10. In this case, reception permission information is stored in the flash ROM 14b in the form of a two-dimensional table in which a portable telephone permitted to receive image data transmitted from each of the plurality of cameras C1 to C3 and the camera which has obtained the image data are associated with each other. In FIG. 2, with respect to a camera which has obtained image data, when reception of the image data by a portable telephone is permitted, “RECEPTION PERMITTED” is stored. When reception is not permitted, “RECEPTION INHIBITED” is stored. Concretely, as shown in FIG. 2, all of the portable telephones P1 to P3 are permitted to receive image data of the camera C1 disposed in the living room. The portable telephones P1 and P2 are permitted to receive image data of the camera C2 installed in the bedroom but the portable telephone P3 is not permitted to receive the image data. Further, only the portable telephone P3 is permitted to receive image data of the camera C3 disposed in the children's room. The reception permission information can be set or changed by various operations in the server 10 or input means such as a keyboard 20 provided for a dedicated terminal.

Contents of Data

FIGS. 3A to 3E are diagrams for describing data transmitted/received between the server 10 and the portable telephones P1 to P3. FIG. 3A shows data transmitted for a request of transmitting image data obtained by the cameras C1 to C3 from each of the portable telephones P1 to P3 to the server 10. FIG. 3B shows data transmitted from each of the portable telephones P1 to P3 to the server 10 for a request of stopping the transmission of the image data obtained by the cameras C1 to C3 to each of the portable telephones P1 to P3. FIG. 3C shows data transmitted from each of the portable telephones P1 to P3 to the server 10 for a request of setting the monitor mode of the cameras C1 to C3. FIG. 3D shows data transmitted from each of the portable telephones P1 to P3 to the server 10 for a request of canceling the monitor mode of the cameras C1 to C3. FIG. 3E shows data at the time of transmitting the image data obtained by the cameras C1 to C3 from the server 10 to each of the portable telephones P1 to P3.

As shown in FIGS. 3A to 3E, in all of data, transmission destination address data is assigned first, and transmission source address data is assigned next. Subsequently, in FIG. 3A, a transmission request command for requesting transmission of the image data, device identification data for identifying a portable telephone as a transmission source, and a camera specifying number for specifying a camera requested to transmit the image data are assigned in order. Data shown in FIG. 3B is similar to that in FIG. 3A except that only the transmission request command in FIG. 3A is changed to a transmission stop command for requesting stop of transmission of the image data. Data shown in FIG. 3C is similar to that in FIG. 3A except that only the transmission request command in FIG. 3A is changed to a monitor mode setting command for requesting setting of a monitor mode of a camera. Data shown in FIG. 3D is similar to that in FIG. 3A except that only the transmission request command in FIG. 3A is changed to a monitor mode cancel command for requesting cancellation of the monitor mode of the camera. In FIG. 3E, image data is assigned subsequent to the transmission source address data. The device identification data may be a password entered by the holder of each of the portable telephones P1 to P3 to identify the portable telephone or a preset device code peculiar to each of the portable telephones P1 to P3 so that the holder does not have to enter the password.

Data Transmission Between Server 10 and Each of Portable Telephones P1 to P3

The server 10 always monitors data flowing on the network 1 and, when the transmission destination address of the data coincides with the address of the server 10, receives the data as data destined to itself. Transmission between the network 1 and the portable telephones P1 to P3 is performed via not-illustrated another server. When the server receives data including a transmission destination address of any of the portable telephones P1 to P3, the server transfers the data to the corresponding portable telephone. Since the transmission source address data is added to the received data, the address of a device as a transmission source can be known.

FIGS. 3A to 3D show data transmitted from the portable telephones P1 to P3, which are data requesting transmission of image data, data requesting stop of the transmission of the image data, data requesting setting of a monitor mode of a camera, and data requesting cancellation of the monitor mode of the camera, respectively.

When the data shown in FIGS. 3A to 3D is transmitted from the portable telephones P1 to P3 to the server 10, as described above, since the command indicative of any of the various requests, the device identification data, and the camera specifying number are added subsequent to the transmission source address data of data received by the server, on the basis of the data, the server 10 performs a data process.

Concretely, in the case where any of the portable telephones P1 to P3 requests the server 10 to transmit image data, the server 10 identifies the portable telephone which has sent the request on the basis of the device identification data in the received data by the reception data identifying unit 17, identifies the camera which is requested to transmit the image data from the camera specifying number, and then determines whether the image data is transmitted from the camera which is requested to transmit the image data by checking the device identification data and the camera identification number identified by the reception data identifying unit 17 with the reception permission information stored in the flash ROM 14b by the reception permission determining unit 18. If it is determined that image data is transmitted from the camera which is requested to transmit the image data to the portable telephone as the request source, transmission of the image data obtained by the camera which is requested to transmit the image data to the portable telephone as a request source is started. Data transmitted from the server 10 to the portable telephone as a request source is the data shown in FIG. 3E. The data is transmitted to the portable telephone as the request source every predetermined cycle. For example, a still image is updated and transmitted every predetermined cycle (for example, every 5 seconds).

In the case where stop of transmission of image data is requested from any of the portable telephones P1 to P3 to the server 10, since only the contents of the request are different from those in the case of requesting transmission of the image data, the server 10 performs similar determination on the basis of the received data. When it is determined to stop transmission of the image data from the camera which is requested to stop transmitting the image data to the portable telephone as the request source, transmission of the image data from the camera requested to stop the transmission to the portable telephone as the request source is stopped.

In the case where any of the portable telephones P1 to P3 requests the server 10 to set the monitor mode of the camera, the server 10 identifies the portable telephone which has sent the request on the basis of the device identification data in the received data, and identifies the camera which is requested to be set in the monitor mode from the camera specifying number in the reception data identifying unit 17. And then, the server 10 determines whether the camera requested to be set in the monitor mode is set in the monitor mode by checking the device identification data and the camera identification number identified in the reception data identifying unit 17 with the reception permission information stored in the flash ROM 14b in the reception permission determination unit 18. In this case, when the request of setting of the monitor mode is sent from all the portable telephones permitted to receive the image data of each camera, under control of the overall control unit 13, the camera is set in the monitor mode.

On the other hand, when any of the portable telephones P1 to P3 requests the server 10 to cancel the monitor mode of the camera, since only the request contents are different from those in the case where setting of the monitor mode of the camera is requested, the server 10 performs similar determination on the basis of the received data. In the case where it is determined to cancel the monitor mode of the camera to which cancellation of the monitor mode is requested, the monitor mode of the camera is canceled. That is, if it is the request from the portable telephone permitted to receive the image data, the monitor mode of the camera for obtaining the image data is canceled.

Transmission of data between the server 10 and the portable telephones P1 to P3, and the like will be further described in the following description of operations of the server 10.

Image Transmitting Operation in Server 10

Operations executed by the server 10 on the basis of the reception permission information shown in FIG. 2 and the data shown in FIGS. 3A to 3E will now be described.

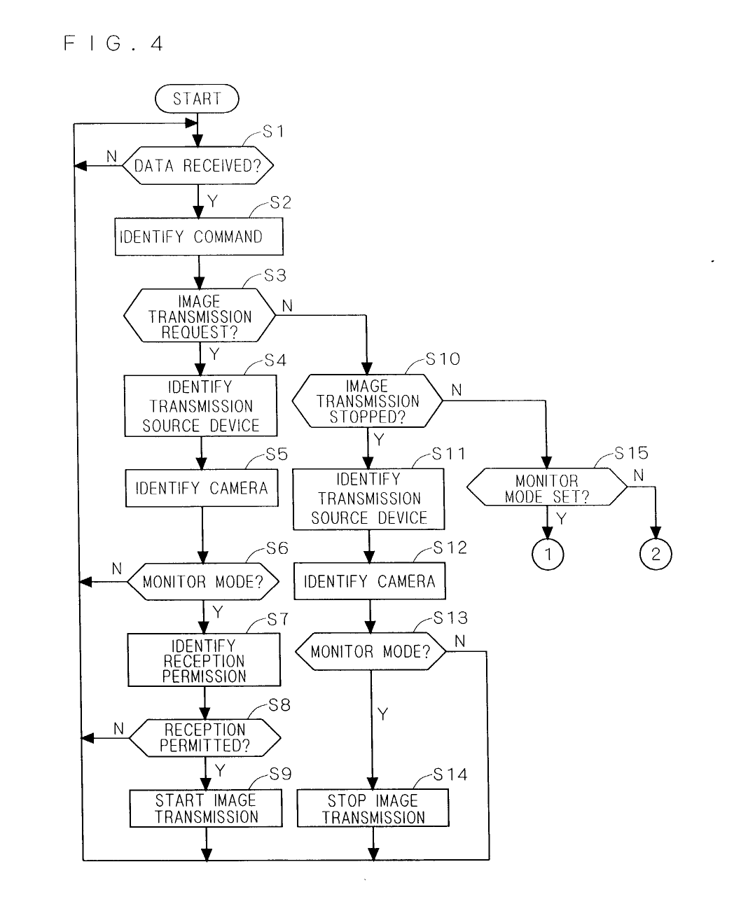

FIGS. 4 to 6 are flowcharts showing the operations executed by the server 10.

When the server 10 enters a state where it always monitors data flowing on the network 1, a flow regarding image transmission starts and the program advances to step S1.

In step S1, whether data destined to the server 10 is received is determined. If the data destined to the server 10 is received by the data input unit 15, the program advances to step S2. If the data input unit 15 does not receive the data destined to the server 10, the determination in step S1 is repeated.

In step S2, the contents (command) of the received data are identified. In this case, the contents of the received data are the transmission request command for requesting transmission of image data, the transmission stop command for requesting stop of transmission of image data, a monitor mode setting command for requesting setting of the monitor mode of the camera, or the monitor mode canceling command for requesting cancellation of the monitor mode of the camera is identified in the reception data identifying unit 17, and the program advances to step S3.

In step S3, whether transmission of image data is requested is determined on the basis of the result identified in step S2. In the case where the contents (command) of the received data are the transmission request command requesting transmission of image data, the program advances to step S4. If the contents are not the transmission request command requesting transmission of image data, the program advances to step S10.

First, the case where the program advances to step S4 will be described.

In step S4, a device as the transmission source of received data is identified. A portable telephone requesting transmission of image data is identified from the device identification data in the received data by the reception data identifying unit 17 and the program advances to step S5.

In step S5, a camera requested to transmit image data is identified. From the camera specifying number in the received data, the reception data identifying unit 17 identifies the camera requested to transmit image data and the program advances to step S6.

In step S6, whether the camera requested to transmit image data is set in the monitor mode (image capturing state) is determined. In this case, the overall control unit 13 of the server 10 controls whether the camera is in the monitor mode as the image capturing state. Since the image capturing state is always stored and managed as the monitor mode setting information whose example is shown in FIG. 7 to be described hereinafter in the flash ROM 14b, the overall control unit 13 determines whether the camera requested to transmit image data is set in the monitor mode on the basis of the monitor mode setting information. In the case where the camera is set in the monitor mode, the program advances to step S7. If the camera is not set in the monitor mode, the program returns to step S1.

In step S7, it is determined whether the portable telephone requesting transmission to the camera which is requested to transmit image data is permitted to receive image data obtained by the camera. In the reception permission determining unit 18, from the portable telephone requesting transmission of image data identified in step S4, the camera requested to transmit image data identified in step S5, and the reception permission information stored in the flash ROM 14b, whether the portable telephone requesting transmission to the camera which is requested to transmit image data is permitted to receive the image data obtained by the camera is determined. After that, the program advances to step S8.

In step S8, on the basis of the result determined in step S7, whether reception of image data by the portable telephone as a request source is permitted is determined in the overall control unit 13. In the case where reception of image data is permitted, the program advances to step S9. In the case where reception of image data is not permitted, the program returns to step S1.

In step S9, under control of the overall control unit 13, transmission of the image data from the data output unit 16 to the portable telephone requiring transmission of image data is started, and the program returns to step S1.

The case where the program advances from step S3 to step S10 when transmission of image data is not requested will now be described.

In step S10, on the basis of the result identified in step S2, whether there is the request of stopping transmission of image data is determined. In the case where the contents (command) of received data are the transmission stop command of requesting stop of transmission of image data, the program advances to step S11. In the case where the contents of the received data are not the transmission stop command of requesting stop of transmission of image data, the program advances to step S15.

In step S11, a device as the transmission source of received data is identified. In a manner similar to step S4, the reception data identifying unit 17 identifies a portable telephone requesting stop of transmission of image data from the device identifying data in the received data, and the program advances to step S12.

In step S12, the camera requested to stop to transmit image data is identified. In a manner similar to step S5, the reception data identifying unit 17 identifies the camera requested to stop to transmit image data from the camera specifying number in the received data, and the program advances to step S13.

In step S13, whether the camera requested to stop to transmit image data is set in the monitor mode as an image capture state is determined. In a manner similar to step S6, on the basis of monitor mode setting information whose example is shown in FIG. 7, the overall control unit 13 determines whether the camera requested to stop to transmit image data is set in the monitor mode. If the camera is set in the monitor mode, the program advances to step S14. If the camera is not set in the monitor mode, the program returns to step S1.

In step S14, under control of the overall control unit 13, transmission of image data to the portable telephone requesting stop of transmission of image data is stopped, and the program returns to step S1.

Since permission of reception of image data obtained in each camera by each portable telephone is managed by one server 10, setting and management of permitting whether an image obtained by each camera can be watched in each portable telephone can be easily performed.

The case where the program advances from step S10 to step S15 in a state where stop of transmission of image data is not requested will now be described.

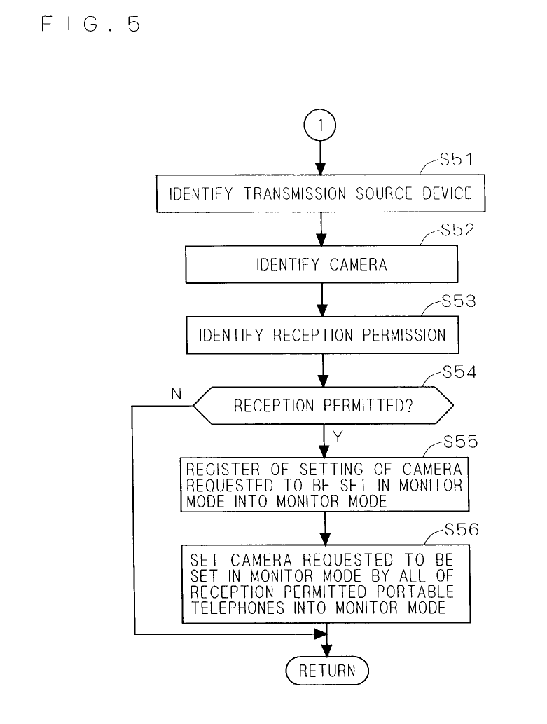

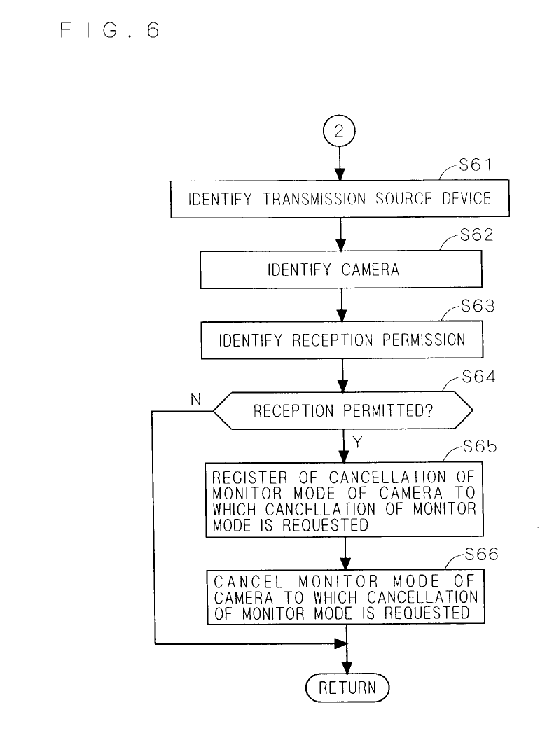

In step S15, on the basis of the result identified in step S2, whether there is a request of setting the camera into the monitor mode is determined. If the contents (command) of received data are the monitor mode setting command of requesting to set the camera in the monitor mode, the program advances to step S51 in FIG. 5. If the contents of the received data are not the monitor mode setting command of requesting to set the camera in the monitor mode, the program advances to step S61 in FIG. 6.

The case where the program advances from step S15 to step 51 in FIG. 5 will be described hereinafter.

In step S51, a device as the transmission source of received data is identified. In a manner similar to step S4 in FIG. 4, the reception data identifying unit 17 identifies a portable telephone requesting setting of the monitor mode from the device identification data in the received data, and the program advances to step S52.

In step S52, a camera requested to be set in the monitor mode is identified. In a manner similar to step S5, the reception data identifying unit 17 identifies a camera requested to be set in the monitor mode from the camera specifying number in the received data, and the program advances to step S53.

In step S53, whether the portable telephone requesting setting of the monitor mode to a camera requested to be set in the monitor mode is permitted to receive image data obtained by the camera is determined. In this case, in the reception permission determining unit 18, from the portable telephone requesting setting of the monitor mode identified in step S51, the camera requested to be set in the monitor mode identified in step S52, and the reception permission information stored in the flash ROM 14b, it is determined whether the portable telephone requesting the setting of the monitor mode to the camera requested to be set in the monitor mode is permitted to receive the image data obtained by the camera. After that, the program advances to step S54.

In step S54, on the basis of the result determined in step S53, the overall control unit 13 determines whether reception of the image data is permitted. If reception of the image data is permitted, the program advances to step S55. If reception of the image data is not permitted, the program returns to step S1.

In step S55, setting of the monitor mode of the camera to which setting of the monitor mode is requested is registered. Under control of the overall control unit 13, registration of the request of setting the monitor mode from the portable telephone is stored with respect to the camera requested to be set in the monitor mode into the monitor mode setting information stored in the flash ROM 14b, and the program advances to step S56.

The monitor mode setting information will be described in detail hereinafter. In the monitor mode setting information shown in FIG. 7, for a combination of a camera and a portable telephone to which reception is permitted in the reception permission information shown in FIG. 2, setting or cancellation of the monitor mode can be registered. However, for a combination of a camera and a portable telephone to which reception is not permitted in the reception permission information shown in FIG. 2, setting and cancellation of the monitor mode cannot be registered. FIGS. 2 and 7 will be described concretely. With respect to the camera C1 in the reception permission information shown in FIG. 2, all of the three portable telephones P1 to P3 are permitted to receive image data. In FIG. 7 showing an example of the monitor mode setting information stored in the flash ROM 14b, for the camera C1, the monitor mode setting is registered for the portable telephones P1 and P2, and the monitor mode setting is canceled for the portable telephone P3. With respect to the camera C2 in the reception permission information shown in FIG. 2, the two portable telephones P1 and P2 are permitted to receive image data. In FIG. 7, for the camera C2, the monitor mode setting is registered with respect to the portable telephones P1 and P2. With respect to the camera C3 in the reception permission information shown in FIG. 2, reception of image data is permitted to only one portable telephone P3. In FIG. 7, for the camera C3, the monitor mode setting is canceled with respect to the portable telephone P3.

In step S56, under control of the overall control unit 13, with respect to each camera, a camera requested to be set in the monitor mode by all of the portable telephones permitted to receive the image data obtained by the camera is set in the monitor mode. After that, the program returns to step S1. On the other hand, with respect to each camera, a camera which is not requested to be set in the monitor mode by at least one of the portable telephones permitted to receive image data obtained by the camera is not set in the monitor mode, and the program returns to step S1. Concretely, from the camera C2 in the reception permission information shown in FIG. 2, the two portable telephones P1 and P2 are permitted to receive image data. In the case where the camera C2 is requested to be set in the monitor mode by both of the two portable telephones (P1 and P2), the camera C2 is set in the monitor mode. That is, when the monitor mode setting information with respect to the camera C2 enters the state shown in FIG. 7, the camera C2 is set in the monitor mode.

On the other hand, with respect to the camera C1 in the reception permission information shown in FIG. 2, all of the three portable telephones P1 to P3 are permitted to receive image data. In the state shown in FIG. 7, however, setting of the monitor mode is requested from only the two portable telephones P1 and P2 to the camera C1, and setting of the monitor mode is not requested from the portable telephone P3 to the camera C1. Therefore, in the state shown in FIG. 7, the camera C1 is not set in the monitor mode.

The case where the program advances from step S15 to step S61 in FIG. 6 will now be described.

In step S61, a device as a transmission source of received data is identified. In a manner similar to step 551 in FIG. 5, the reception data identifying unit 17 identifies a portable telephone requesting cancellation of the monitor mode from the device identification data in the received data, and the program advances to step S62.

In step S62, a camera to which cancellation of the monitor mode is requested is identified. In a manner similar to step S5, the reception data identifying unit 17 identifies a camera to which cancellation of the monitor mode is requested from the camera specifying number of the received data, and the program advances to step S63.

In step S63, whether the portable telephone requesting the cancellation of the monitor mode to the camera to which the cancellation of the monitor mode is requested is permitted to receive image data obtained by the camera is determined. In the reception permission determination unit 18, from the portable telephone requesting cancellation of the monitor mode identified in step S61, the camera to which cancellation of the monitor mode is requested, which is identified in step S62, and the reception permission information stored in the flash ROM 14b, it is determined whether the portable telephone requesting cancellation of the monitor mode to the camera to which cancellation of the monitor mode is requested is permitted to receive the image data obtained by the camera. After that, the program advances to step S64.

In step S64, on the basis of the result of determination in step S63, the overall control unit 13 determines whether reception of the image data is permitted. If reception of the image data is permitted, the program advances to step S65. If reception of the image data is not permitted, the program returns to step S1.

In step S65, cancellation of the monitor mode of the camera to which cancellation of the monitor mode is requested is registered. Under control of the overall control unit 13, in the monitor mode setting information stored in the flash ROM 14b, registration of the request of canceling the monitor mode from the portable telephone is stored with respect to the camera to which the monitor mode cancellation is requested. After that, the program advances to step S66.

In step S66, the monitor mode of the camera to which the monitor mode cancellation is requested is canceled, and the program returns to step S1. Concretely, the two portable telephones P1 and P2 are permitted to receive image data obtained by the camera C2 in the reception permission information shown in FIG. 2. When cancellation of the monitor mode of the camera C2 is requested from one of the portable telephones P1 and P2 in a state where the camera C2 is set in the monitor mode (state shown in FIG. 7), the monitor mode of the camera C2 is canceled. In step S66, if the monitor mode of the camera to which cancellation of the monitor mode is requested is already canceled, the state where the monitor mode of the camera is canceled is maintained.

Therefore, only under agreement of all the holders of the portable telephones capable of receiving image data obtained by each camera, each of the cameras can be set in the monitor mode in which images obtained by the camera can be watched by the portable telephones. Consequently, in the case where even one of the holders of the portable telephones capable of watching images obtained by each camera does not want to show the images obtained by the camera, the state that the images obtained by the camera cannot be watched from all of the portable telephones can be set. As a concrete example, when all of the users left a room, the camera can be set in the monitor mode. When even one of the users stays in the room, monitoring can be restricted. As a result, the privacy of the users in the room can be sufficiently protected.

Second Preferred Embodiment

In the foregoing first preferred embodiment, as shown in FIGS. 5 and 6, with respect to each camera, a camera requested to be set in the monitor mode by all of portable telephones permitted to receive image data obtained by the camera is set in the monitor mode. When even one of the portable telephones permitted to receive the image data obtained by the camera requests canceling of the monitor mode of the camera, the monitor mode of the camera is canceled. Alternately, setting and cancellation of the monitor mode can be performed in the following patterns or the like.

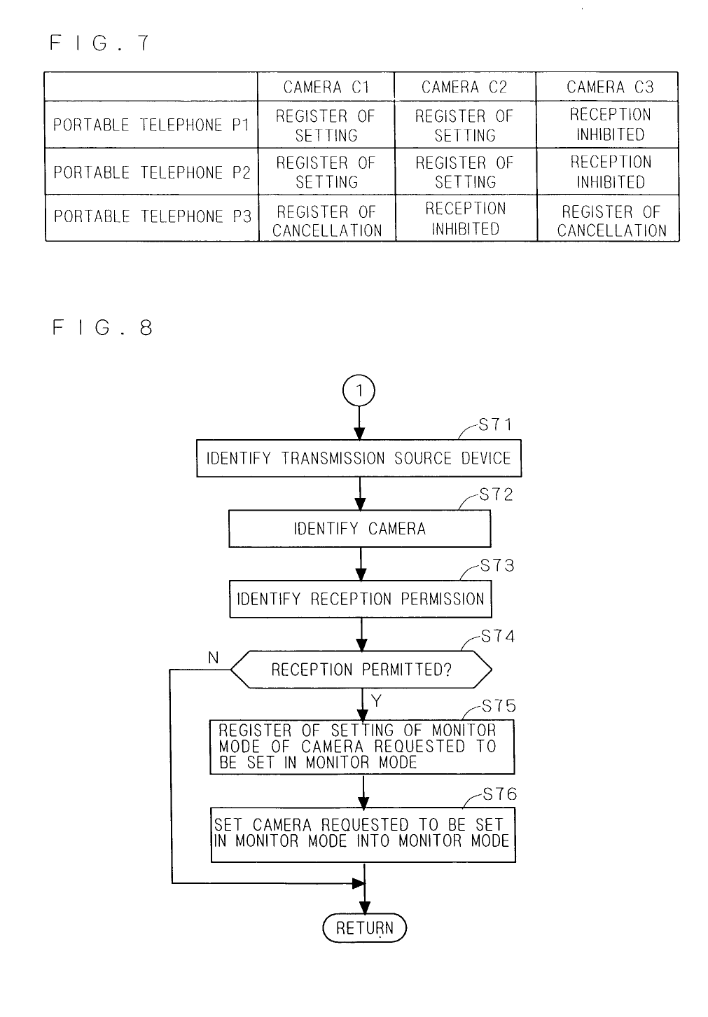

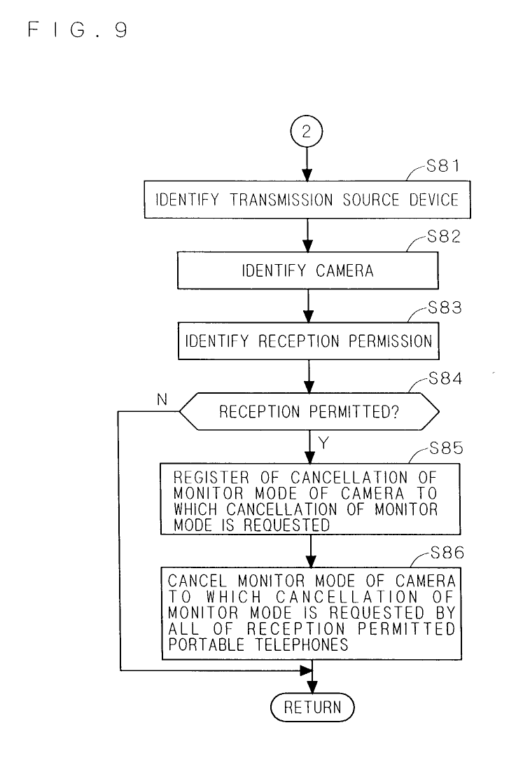

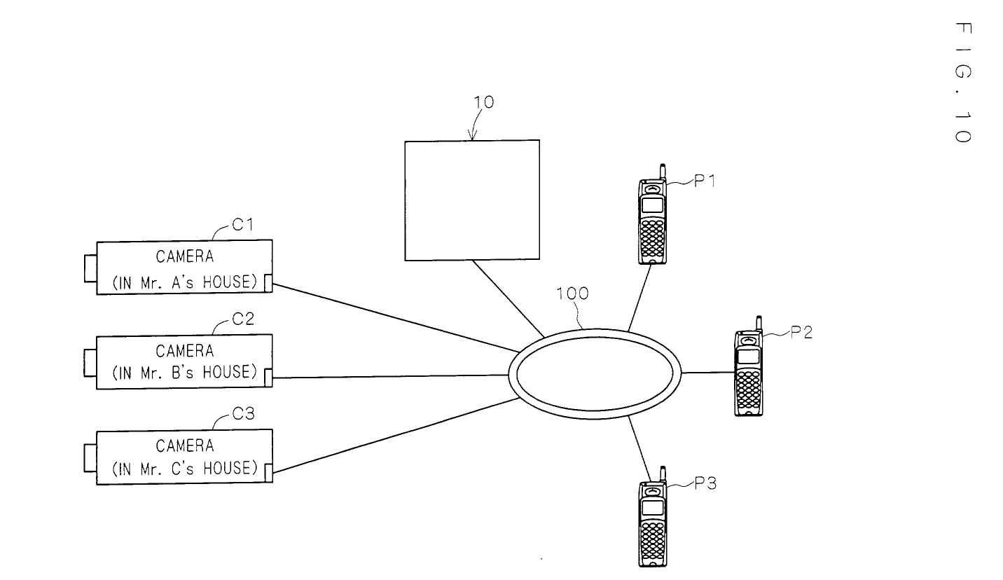

FIGS. 8 and 9 are flowcharts for describing operations of the server 10 in an preferred embodiment of setting a camera in a monitor mode in the case where the camera which has obtained image data is requested to be set in the monitor mode by at least one of portable telephones permitted to receive the image data of the camera. The case where the program advances from step S15 in FIG. 4 to step S71 in FIG. 8 when the contents (command) of data received by the server 10 are a monitor mode setting command of requesting a camera to be set in the monitor mode, and the case where the program advances from step S15 in FIG. 4 to step S81 in FIG. 9 when the contents of the data are not a monitor mode setting command of requesting a camera to be set in the monitor mode will be described.

First, the case where the program advances from step S15 in FIG. 4 to step S71 in FIG. 8 will be described.

In step S71, the server 10 identifies a device as the transmission source of the data received from the portable telephones P1 to P3. In a manner similar to step S51 in FIG. 5, the reception data identifying unit 17 identifies a portable telephone requesting setting of the monitor mode from the device identification data in the received data and the program advances to step S72.

In step S72, a camera requested to be set in the monitor mode is identified. In a manner similar to step S52 in FIG. 5, the reception data identifying unit 17 identifies a camera requested to be set in the monitor mode from the camera specifying number of the received data, and the program advances to step S73.

In step S73, whether the portable telephone requesting setting of the monitor mode to the camera which is requested to be set in the monitor mode is permitted to receive image data obtained by the camera is determined. In the reception permission determining unit 18, from the portable telephone requesting setting of the monitor mode identified in step S71, the camera requested to be set in the monitor mode identified in step S72, and the reception permission information stored in the flash ROM 14b, whether the portable telephone requesting setting of the monitor mode to the camera which is requested to be set in the monitor mode is permitted to receive the image data obtained by the camera is determined. After that, the program advances to step S74.

In step S74, on the basis of the result of determination in step S73, the overall control unit 13 determines whether reception of the image data is permitted. If reception of image data is permitted, the program advances to step S75. If reception of image data is not permitted, the program returns to step S1.

In step S75, setting of the monitor mode of the camera to which setting of the monitor mode is requested is registered. Under control of the overall control unit 13, in the monitor mode setting information stored in the flash ROM 14b, registration that the portable telephone requests setting of the monitor mode to the camera requested to be set in the monitor mode is stored, and the program advances to step S76.

In step S76, the camera requested to be set in the monitor mode is set in the monitor mode, and the program returns to step S1. Concretely, the two portable telephones P1 and P2 are permitted to receive image data of the camera C2 in the reception permission information shown in FIG. 2. In the case where at least one of the two portable telephones (P1 and P2) requests the camera C2 to be set in the monitor mode, the monitor mode of the camera C2 is set. In step S76, if the camera requested to be set in the monitor mode is already set in the monitor mode, the state where the camera is set in the monitor mode is maintained.

Next, the case where the program advances from step S15 in FIG. 4 to step S81 in FIG. 9 will be described.

In step S81, a server 10 identifies the device as the transmission source of data received from the portable telephone P1, P2 or P3. In a manner similar to step S61 in FIG. 6, the reception data identifying unit 17 identifies a portable telephone requesting cancellation of the monitor mode from the device identifying data in the received data, and the program advances to step S82.

In step S82, a camera to which cancellation of the monitor mode is requested is identified. In a manner similar to step S62 in FIG. 6, the reception data identifying unit 17 identifies a camera to which cancellation of the monitor mode is requested from the camera specifying number in the received data, and the program advances to step S83.

In step S83, whether the portable telephone requesting cancellation of the monitor mode to the camera to which cancellation of the monitor mode is requested is permitted to receive image data obtained by the camera is determined. From the portable telephone requesting cancellation of the monitor mode identified in step S81, the camera to which cancellation of the monitor mode is requested, identified in step S82, and the reception permission information stored in the flash ROM 14b, the reception permission determining unit 18 determines whether the portable telephone requesting cancellation of the monitor mode to the camera to which cancellation of the monitor mode is requested is permitted to receive image data obtained by the camera. After that, the program advances to step S84.

In step S84, on the basis of the result determined in step S83, the overall control unit 13 determines whether reception of the image data is permitted. If reception of image data is permitted, the program advances to step S85. If reception of image data is not permitted, the program returns to step S1.

In step S85, cancellation of the monitor mode of the camera to which cancellation of the monitor mode is requested is registered. Under control of the overall control unit 13, registration that the portable telephone requests cancellation of the monitor mode to the camera to which cancellation of the monitor mode is requested is stored in the monitor mode setting information stored in the flash ROM 14b, and the program advances to step S86.

In step S86, under control of the overall control unit 13, the monitor mode of each camera to which cancellation of the monitor mode is requested by all of portable telephones permitted to receive image data obtained by the camera is canceled, and the program returns to step S1. Concretely, with respect to the camera C2 in the reception permission information shown in FIG. 2, the two portable telephones P1 and P2 are permitted to receive the image data obtained by the camera C2. In the case where both of the two portable telephones (P1 and P2) request cancellation of the monitor mode to the camera C2, the monitor mode of the camera C2 is canceled. In step S86, if the monitor mode of the camera is already canceled, the state where the monitor mode of the camera is canceled is maintained.

In this case, by even one of holders of portable telephones capable of watching images obtained by cameras, the monitor mode in which the images obtained by each camera can be watched on the portable telephones can be set. Specifically, a camera can be set in the monitor mode when, for example, at least one of the users in a room leaves the room. Consequently, even in the case where there are other users in the room, by receiving image data obtained by the camera by the portable telephone, the state of the room can be monitored.

Modification

In the foregoing preferred embodiment, each of the image data generating unit 1 1, transmission data generating unit 12, reception data identifying unit 17 and reception permission determining unit 18 in the server 10 is constructed by a dedicated electronic circuit. The present invention is not limited to the configuration. A data process and a computing process executed by the image data generating unit 11, transmission data generating unit 12, reception data identifying unit 17 and reception permission determining unit 18 may be executed in accordance with a program in the flash ROM 14bby the overall control unit 13 constructed mainly by a CPU.

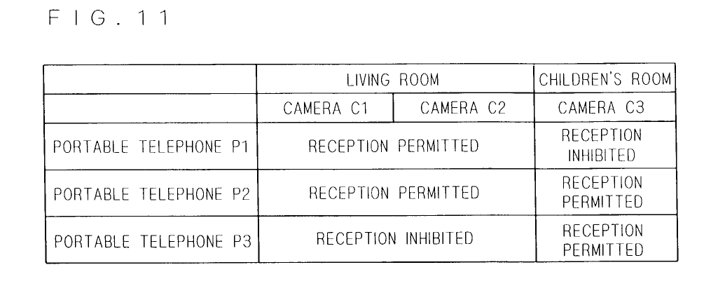

In the foregoing preferred embodiment, as shown in FIG. 1, image data obtained by the cameras C1 to C3 is once transmitted to the server 10 in a house or the like, and the server 10 and the portable telephones P1 to P3 are connected to the network 1. The connection form of each device is not limited to the above. As shown in FIG. 10, all of the server 10, cameras C1 to C3 and portable telephones P1 to P3 may be connected to a network 100. As a concrete example used as the preferred embodiment, there is a form of providing service such that the cameras C1 to C3 are disposed in houses, the server 10 is installed in a guard company or a facility of elderly people care giving organization, workers of the guard company or the elderly people care giving organization monitor states of the houses by using the portable telephones P1 to P3 during patrol so that the presence/absence of abnormal state can be recognized.

In the foregoing preferred embodiments, as shown in FIG. 2, reception permission of image data obtained by each of cameras C1 to C3 to the portable telephones P1 to P3 is set and managed. The present invention is not limited to the form but a plurality of cameras may be set as a group, and reception permission of image data obtained by the group can be set and managed for the portable telephones P1 to P3. As a concrete example used in such an preferred embodiment, a case such that there is a big room in a house and a plurality of cameras are installed for the room can be considered. FIG. 11 is a diagram showing an example of reception permission information stored in the flash ROM 14 in the server 10 at the time of setting and managing reception permission of the portable telephones P1 to P3 while regarding a plurality of cameras as a group. FIG. 11 shows an example that both the cameras C1 and C2 are disposed in a living room, and reception permission of the portable telephones P1 to P3 is set by using the two cameras as a group. In this case, permission of whether image data obtained by all of the cameras in the camera group constituted by two or more cameras in a plurality of cameras can be received by each portable telephone is set and managed by a single server. Consequently, permission of whether image data obtained by each camera can be received by each portable telephone can be easily set. It is also possible to group the portable telephones, pre-register whether image data obtained by each camera can be received for each group, and control transmission of image data on the basis of the pre-registration.

In the foregoing preferred embodiments, as an example of monitor means for receiving an image obtained by the cameras C1 to C3, a portable telephone is mentioned. However, the present invention is not limited to the portable telephone but a personal computer or the like can be also used. Further, the image display device may also be a personal digital assistant (PDA) or the like.

In the foregoing preferred embodiments, a still image is transmitted every predetermined cycle from the server 10 to the portable telephones P1 to P3. The present invention is not limited to still images but moving images may be transmitted.

In the foregoing preferred embodiments, the contents (command) of data received by the server 10 from the portable telephones P1 to P3 include only start of transmission of image data, stop of transmission of image data, setting of the monitor mode of a camera, and request of cancellation of the monitor mode of a camera. The present invention is not limited to the above. The contents (command) of data received by the server 10 may be a request of changing the image capturing direction of the cameras C1 to C3. When the contents (command) of data received by the server 10 are a change in the image capturing direction of the cameras C1 to C3, the following method may be used. After step S15 in FIG. 4, in a routine different from the flowcharts shown in the diagrams, the data contents are identified in the server 10, instruction data from the overall control unit 13 in the server 10 is transmitted to the camera control unit in the cameras C1 to C3 via communication lines L1 to L3 or the network 100. Under control of the camera control unit, the image capturing direction of the cameras C1 to C3 may be changed by an image capturing angle adjusting mechanism.

In the foregoing preferred embodiments, the monitor mode of the cameras C1 to C3 is set or canceled by starting or stopping image capture under control of the camera control unit in accordance with an instruction included in data transmitted from the server 10 to the cameras C1 to C3. The present invention is not limited to the method but the following method may be also used. Each camera is actually in an image capturing state. Image data obtained by each camera is transmitted to the server 10. In the server 10, by switching between a state where the monitor mode is set and image data can be transmitted to each portable telephone and a state where the monitor mode is canceled and image data cannot be transmitted to each portable telephone, the monitor mode of the cameras C1 to C3 may be set or canceled.

Although a camera is specified at the time of setting or canceling the monitor mode in the foregoing preferred embodiments (S52, S62, S72 and S82), it is also possible to regard that setting or cancellation of the monitor mode is requested to all of cameras of which images are permitted to be received by the portable telephone as a transmission source. Specifically, in the example of FIG. 2, when a monitor mode setting request (without data specifying a camera) is sent from the portable telephone P3, it is regarded that setting of the monitor mode is requested to the cameras C1 and C3 of which image is permitted to be received. Thus, an operation of specifying a camera in the operation of the portable telephone can be omitted, and operability of setting or canceling the monitor mode is improved.

While the invention has been shown and described in detail, the foregoing description is in all aspects illustrative and not restrictive. It is therefore understood that numerous modifications and variations can be devised without departing from the scope of the invention.

What is claimed is:

1. A camera server system connected to a plurality of image display devices via a communication network, comprising:
a plurality of cameras; and
a server for performing data communications with the plurality of cameras, wherein
said server includes:
a storing unit for storing information indicating, for each display device, images obtained by which cameras among the plurality of cameras are permitted to be received by said each display device; and
a control unit for referring said information and conducting a process related to an objective camera in response to a command requested only from respective ones of image display devices which are permitted to receive images obtained by said objective camera.

2. The camera server system according to claim 1, wherein
said control unit conducts said process related to said objective camera only when a same command is requested from all of said respective ones of image display devices which are permitted to receive images obtained by said objective camera.

3. The camera server system according to claim 1, wherein
said control unit conducts said process related to said objective camera in response to a command requested by either one of image display devices which are permitted to receive images obtained by said objective camera.

4. The camera server system according to claim 1, wherein
said command includes a command for requesting a start of image capturing by said objective camera.

5. The camera server system according to claim 1, wherein
said command includes a command for requesting a stop of image capturing by said objective camera.

6. The camera server system according to claim 1, wherein
said command includes a command for requesting transmission of image data obtained by said objective camera.

7. The camera server system according to claim 1, wherein
said command includes a command for stopping transmission of image data obtained by said objective camera.

8. The camera server system according to claim 1, wherein
said command includes a command for requesting a change in an image capturing direction of said objective camera.

9. The camera server system according to claim 1, wherein
said information includes a part which is set for a camera group constituting of two or more cameras among said plurality of cameras.

10. A server connected to a plurality of cameras for obtaining image data and a plurality of image display devices via a communication network, comprising:
a storing unit for storing information indicating, for each display device, images obtained by which cameras among the plurality of cameras are permitted to be received by said each display device; and
a control unit for referring said information and conducting a process related to an objective camera in response to a command requested only from respective ones of image display devices which are permitted to receive images obtained by said objective camera.

11. The server according to claim 10, wherein
said control unit conducts said process related to said objective camera only when a same command is requested from all of said respective ones of image display devices which are permitted to receive images obtained by said objective camera.

12. The server according to claim 10, wherein
said control unit conducts said process related to said objective camera in response to a command requested by either one of image display devices which are permitted to receive images obtained by said objective camera.

13. The server according to claim 10, wherein
said command includes a command for requesting a start of image capturing by said objective camera.

14. The server according to claim 10, wherein
said command includes a command for requesting a stop of image capturing by said objective camera.

15. The server according to claim 10, wherein
said command includes a command for requesting transmission of image data obtained by said objective camera.

16. The server according to claim 10, wherein
said command includes a command for stopping transmission of image data obtained by said objective camera.

17. The server according to claim 10, wherein
said information includes a part which is set for a camera group constituting of two or more cameras among said plurality of cameras.

18. A computer program product storing a software program capable of allowing a computer provided in a server connected to a plurality of cameras for obtaining image data and a plurality of image display devices via a communication network to execute a process, said process comprising the steps of:
storing information indicating, for each display device, images obtained by which cameras among the plurality of cameras are permitted to be received by said each display device; and
referring said information and conducting a process related to an objective camera in response to a command requested only from respective ones of image display devices which are permitted to receive images obtained by said objective camera.

19. The computer program product according to claim 18, wherein
said computer program product is recorded on a computer readable recording medium.

20. The computer program product according to claim 19, wherein
said computer program product can be installed from a recording medium located outside of said server to said computer readable recording medium.
